(19) United States
(12) Patent Application Publication
(10) Pub. No.: US 2008/0209751 A1
(43) Pub. Date: Sep. 4, 2008

(54) Dryer exhaust duct alarm

(76) Inventors: Thomas J. Asciolla, Monroe Township, NJ (US); Lawrance J. Pa, Middle Town, NJ (US)

Correspondence Address: JACKSON WALKER, L.L.P., 112 E. PECAN, SUITE 2400, SAN ANTONIO, TX, 78205, US

(21) Appl. No.: 12/070,577

(22) Filed: Feb. 20, 2008

Related U.S. Application Data
(60) Provisional application No. 60/902,203, filed on Feb. 20, 2007.

(51) Int. Cl. F26B 19/00

(52) U.S. Cl. 34/89

(57) ABSTRACT

A dryer exhaust duct alarm detects the presence of lint or other obstructions in an exhaust duct or vent. A thin lever is suspended within the duct and is slightly cupped in shape to more effectively capture air flow. In the presence of uninhibited air flow, the lever is substantially displaced from its initial substantially-vertical position toward a substantially horizontal position. But when airflow is inhibited, the lever is not sufficiently displaced. A detector detects operation of the dryer. If the dryer operates for a determined period of time but the lever is not sufficiently displaced, the user is alerted of the problem. Other data may also be presented to the user, including real-time data over a communication medium.

This application claims the benefit of U.S. provisional application 60/902,203, filed Feb. 20, 2007, which is incorporated herein by reference.

### BACKGROUND

This specification relates to the field of home appliance safety and more particularly to an alarm for detecting obstructions in a dryer vent.

Dryer vents are a necessary part of a drying system. In a typical consumer- or commercial-grade dryer, clothes are dried with heated air. Dry, cool ambient air is pulled into the dryer and heated. The heated air extracts moisture from the wet clothes. The now-moist air must be exhausted from the system and replaced with dry air.

A result of this process is that lint and other flammable material is sometimes extracted from the clothes being dried. This lint can then be expelled with the exhaust air. Most dryers provide a lint trap to capture the bulk of this lint, but the lint traps are imperfect, and some lint will escape into the exhaust vent. If lint builds up, it can decrease the efficiency of the dryer and even present a fire hazard if lint ends up in the heating element.

### BRIEF DESCRIPTION OF THE DRAWINGS

FIG. 1 is a perspective view of a dryer exhaust duct alarm;

FIG. 2 is a cutaway view of a dryer exhaust duct alarm showing the lever with more particularity;

FIG. 2A is a side view of a lever showing the curvature of the cup shape.

FIG. 2B is a side view of a lever in various positions in response to air flow.

FIG. 2C is a cutaway view of a dryer exhaust duct alarm showing additional details of the lever with more particularity.

FIG. 3 is an enlarged perspective view of a dryer exhaust duct alarm showing the displacement sensor with more particularity;

FIG. 4 is an enlarged view of a dryer exhaust duct alarm showing a microphone with more particularity; and

FIG. 5 is a block diagram of a dryer system equipped with an exhaust duct alarm system.

### DETAILED DESCRIPTION OF THE EMBODIMENTS

A dryer exhaust duct alarm detects the presence of lint or other obstructions in an exhaust duct or vent. A thin lever is suspended within the duct and may be slightly cupped in shape to more effectively capture air flow. In the presence of uninhibited air flow, the lever is substantially displaced from its initial substantially-vertical position toward a substantially horizontal position. But when airflow is inhibited, the lever is not sufficiently displaced. A detector detects operation of the dryer. If the dryer operates for a determined period of time but the lever is not sufficiently displaced, the user is alerted of the problem. Other data may also be presented to the user, including real-time data over a communication medium.

A dryer exhaust duct alarm will now be described with more particular reference to the attached drawings. Hereafter, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance or example of an element and the un-hyphenated form of the reference numeral refers to the element generically or collectively. Thus, for example, widget 102-1 may refer to a “pen,” which may be an instance or example of the class of “writing implements.” Writing implements may be referred to collectively as “writing implements 102” and any one may be referred to generically as “a writing implement 102.”

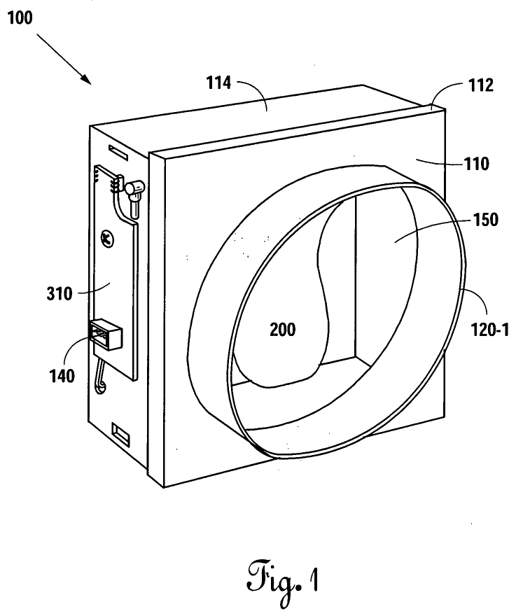

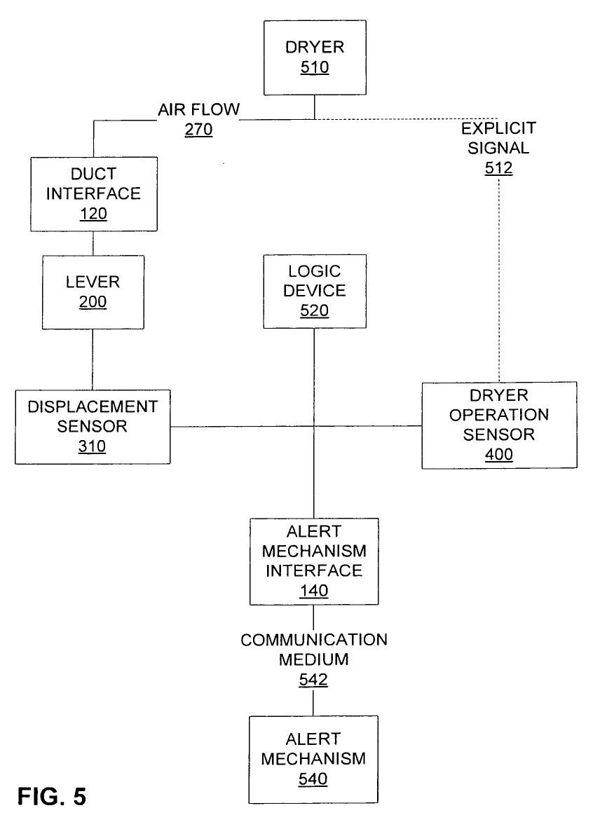

FIG. 1 is a perspective view of a dryer exhaust duct alarm 100. The alarm includes an enclosure 110, which may consist of a first layer 112 and a second layer 114 that are joined together. There are duct interfaces 120 on either side of enclosure 110. The duct interfaces are configured to interface with a standard dryer duct and to promote free air flow through conduit 150. Dryer exhaust duct alarm 100 also includes an alert mechanism interface 140, which may be contained within an electronics housing 310. Alert mechanism interface 140 is configured to provide communication with an alert mechanism 540 (FIG. 5). Suspended within conduit 150 is lever 200, which is adapted to be displaced in the presence of air flow.

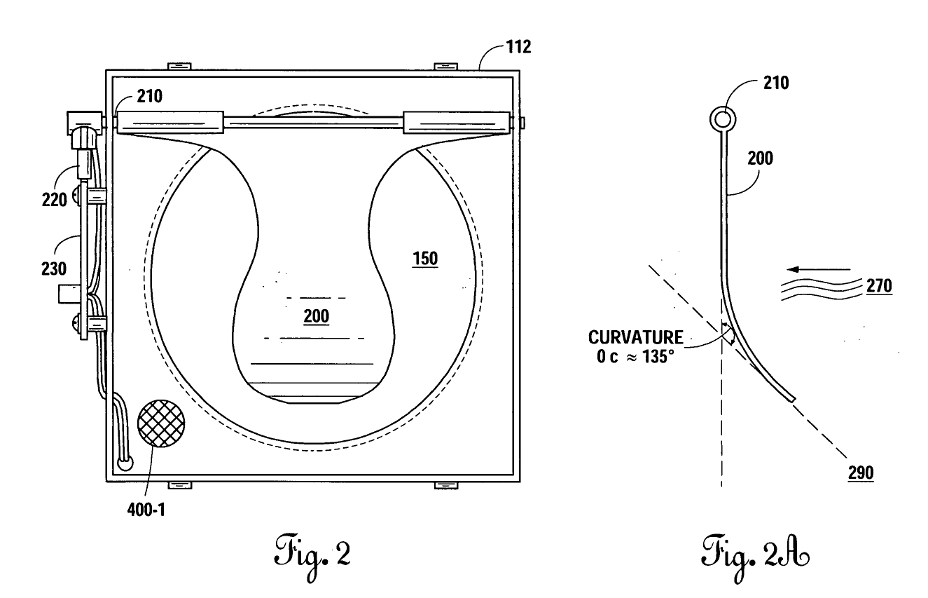

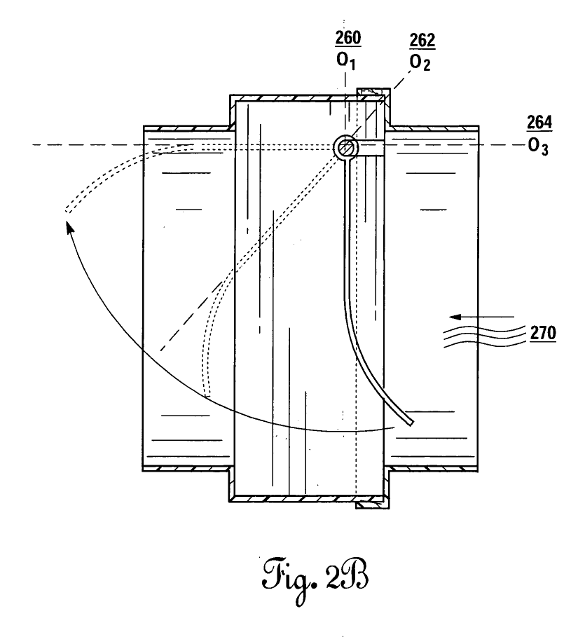

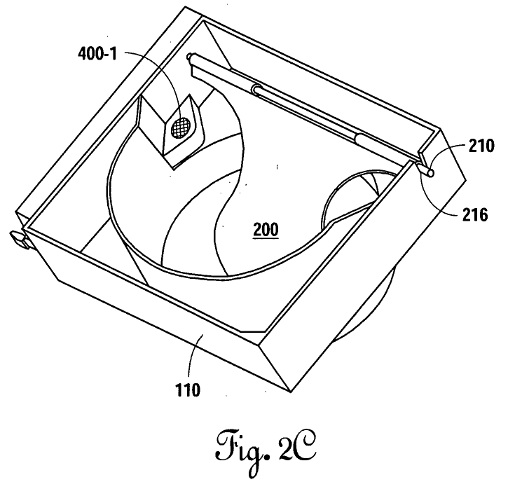

FIG. 2 discloses lever 200 with more particularity. In this cutaway view, there can be seen a portion of first layer 112. An axle 210 is provide from which lever 200 is suspended. As is seen in this view, lever 200 may be substantially bell shaped, and should be suspended so as to move freely in conduit 150. There is also attached to axle 210 a metallic bar 220, which rotates with axle 210. A mounting board 230 is seen, on which electronic components may be mounted. Mounting board 230 is housed within electronics housing 240. There is also seen in this view the placement of a microphone 400-1, which may act as a dryer operation sensor 400.

FIG. 2A shows lever 200 in a side view, suspended from axle 210. The angular curvature 290 is selected to form a substantially concave lever 200, which will effectively receive air flow 270. IN some embodiments, the angular curvature 290 may be between 120 and 150 degrees. In the specific embodiment shown in FIG. 2A, angular curvature 290 is approximately 135 degrees.

FIG. 2B is a side view of lever 200 demonstrating several possible positions. When there is no air flow, lever 200 is in a rest position θ1 260. In some embodiments, θ1 260 may correspond to a substantially vertical angle. In the presence of air flow 270, lever 200 will be displaced, first passing through position θ2 262. In some embodiments, angle θ2 262 may be chosen so that lever 200 will be displaced to at least position θ2 262 in the presence of air flow 270, even if air flow 270 is partially obstructed. In these embodiments, a detector that detects the lever 200 passing through position θ2 262 may serve as dryer operation sensor 400. In those cases, position θ2 262 may be chosen depending on the weight and shape characteristics of lever 200. In some embodiments, θ2 262 may be 25 degrees from vertical.

There is also shown position θ3 264. In nominal operation, for example in the absence of an obstruction, in the presence of air flow 270, lever 200 will be displaced through position θ2 262 and up to position θ3 264. Position θ3 264 may represent a substantially or nearly horizontal position. Lever 200 resting in position θ3 264 in the presence of air flow 270 represents nominal operating conditions.

FIG. 2C discloses additional features of lever 200. In this view, it can be seen that axle 210 may be suspended through an aperture 216 in enclosure 110. This view also discloses a useful position for microphone 400-1.

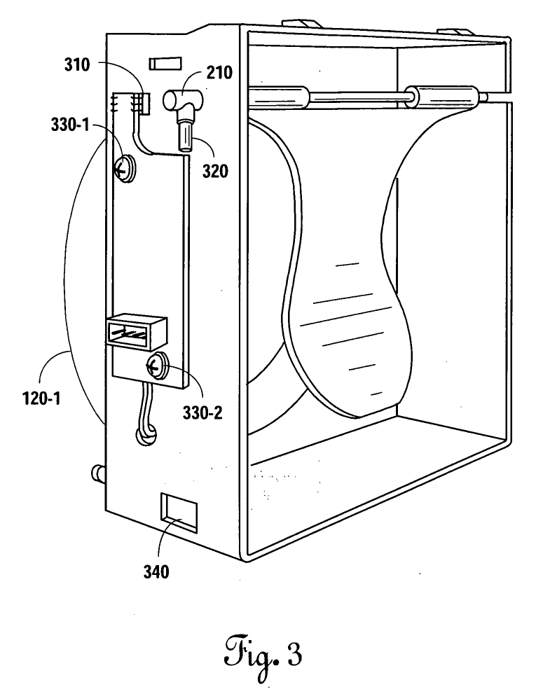

FIG. 3 is an enlarged view of a dryer exhaust duct alarm 100. This view more particularly discloses certain components. In this view, it is more clear that, attached to axle 210 there is a metallic bar 320. This metallic bar is fixed with respect to axle 210, such that when axle 210 rotates, metallic bar 320 also rotates through the same angle. A displacement sensor 310 is provided, which may be any type of sensor that detects the displacement of metallic bar 320. In some embodiments, this may be a simple proximity trigger. In those cases, displacement sensor is placed so as to trigger when metallic bar 320 passes through a desired angle, such as θ3 264 (FIG. 2B) or θ2 262 (FIG. 2B).

In other embodiments, displacement sensor 310 and metallic bar 320 may be replaced with another angle-sensing mechanism. For example, a high-resolution device such as a synchro may be used.

In nominal operation, displacement sensor 310 will detect that metallic bar 320 is resting at the desired angle θ3 264 (FIG. 2B). There can also be seen in this view standoffs 330 and a clip insert, which may be used for attaching electronics housing 310.

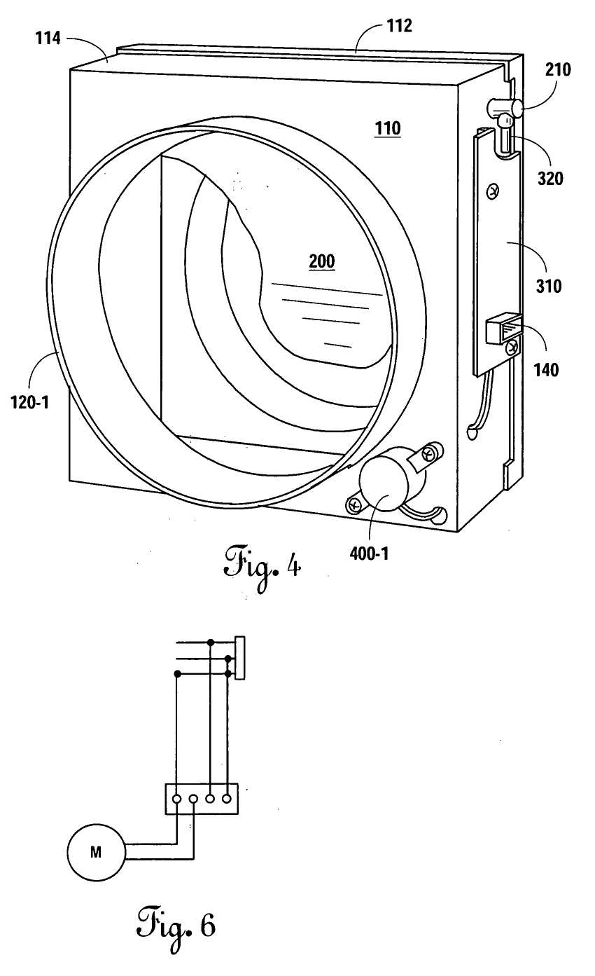

FIG. 4 is an enlarged view of a dryer exhaust duct alarm 100, showing more particularly microphone 400-1, which is an example of a dryer operation sensor 400. It is within the grasp of persons having ordinary skill in the art to select from a number of available microphone styles, including such well known examples as capacitive, electret, piezoelectric, and carbon microphones, among others. It will also be appreciated that the intended function of microphone 400-1 is to detect the operation of the dryer, and thus it can be interchanged with other types of dryer operation detectors. For example, in some embodiments, an inductive clamp may be used as a dryer operation sensor 400. In those cases, the clamp may be attached to the dryer's power supply cord, so that when current flows through the cord to the dryer, it is detected that the dryer is operating. In other embodiments, a dryer exhaust duct alarm 100 may be installed by the original equipment manufacturer (OEM) of a dryer as part of the original equipment. In those cases, dryer operation sensor 400 may be provided as an explicit signal indicating that the dryer is operating.

FIG. 5 is a block diagram showing the interconnections between components of a dryer exhaust duct alarm 100. Dryer 510 provides air flow 270 into duct interface 120. Air flow 270 strikes lever 200, displacing it through an angle. Displacement sensor 310 detects the angular displacement of lever 200. Dryer operation sensor 400 may or may not be directly coupled to dryer 510. Dryer operation sensor 400 operates to detect that the dryer is operating. Logic device 520 may be any analog or digital device capable of processing the necessary signals. Logic device 520 receives from dryer operation sensor 400 a signal indicating that dryer 510 is operating. Logic device 520 then checks the displacement of lever 200 via displacement sensor 310. If dryer 520 has been operating for a sufficient time, but the angular displacement of lever 200 is still inadequate, then logic device 520 generates an alarm condition and may provide data to alert mechanism interface 140. Alert mechanism interface 140 may connect logic device 520 to alert mechanism 540 via a communication medium 542. Communication medium 542 may be a medium such as a simple wired signal, a serial or parallel interface, an infrared interface, or a wired or unwired internet protocol interface. If alert mechanism 540 receives an alarm condition from logic device 520, it responds accordingly.

For example, in some embodiments, alert mechanism 540 may include a combination of audible and visible alarms. In other embodiments, and particularly those where dryer exhaust duct alarm is provided by the OEM, the alert mechanism may include a display that includes more detailed data, including real-time and trending data, which may be displayed graphically. In yet other embodiments, alert mechanism interface 140 may be an interface capable of connecting to an internet protocol (IP) or other similar network. In those cases, data may be provided to other network-aware devices, including computers, e-mail and hand-held wireless devices. The trending data and/or alarm condition may be conveyed graphically, or through such services as an e-mail sent to a user's e-mail account or a text message sent to a user's mobile phone.

While the subject of this specification has been described in connection with one or more exemplary embodiments, it is not intended to limit the claims to the particular forms set forth. On the contrary, the appended claims are intended to cover such alternatives, modifications and equivalents as may be included within their spirit and scope.

What is claimed is:

1. A dryer exhaust duct alarm for alerting a user to obstructions in a dryer exhaust duct, the dryer exhaust duct alarm comprising:
a lever hingedly suspended in the exhaust duct and in fluid communication with the exhaust duct;
a first sensor in electrical communication with the lever and adapted to detect displacement of the lever from an initial position;
a second sensor adapted to detect operation of a dryer providing air flow to the exhaust duct; and
a logic device in communication with the first sensor and the second sensor;
wherein the logic device is configured to determine that the displacement of the lever is inadequate after the dryer has operated for a time period, and in response to the determination, generate an alarm condition.

2. The alarm of claim 1 wherein the initial position is substantially vertical.

3. The alarm of claim 1 further comprising an alarm mechanism, wherein the alert mechanism is configured to provide data upon an alarm condition.

4. The alarm of claim 3 wherein the alert mechanism comprises an audible alarm.

5. The alarm of claim 3 wherein the alert mechanism comprises a visible indicator.

6. The alarm of claim 1 further comprising:
a network interface communicatively coupled to the logic device;
wherein the logic device is configured to provide data through the network interface.

7. The alarm of claim 6 wherein the data provided through the network interface are trend data.

8. The alarm of claim 10 wherein the trend data re real-time data.

9. The alarm of claim 10 further comprising a display, wherein the display is configured to display a representation of the data.

10. The alarm of claim 1 wherein the second sensor is an inductive clamp configured to detect current flow through a conductor supplying power to the dryer.

11. The alarm of claim 1 wherein the second sensor is a microphone configured to detect the sound of air flowing in the duct.

12. The alarm of claim 11 wherein the microphone is a capacitive microphone.

13. The alarm of claim 11 wherein the microphone is a piezoelectric microphone.

14. The alarm of claim 1 wherein the lever is cupped.

15. The alarm of claim 1 wherein a thickness of the lever is between one-half millimeter and three millimeters.

16. The alarm of claim 15 wherein a thickness of the lever is approximately one millimeter.

17. The alarm of claim 10 wherein the lever is cupped when viewed substantially horizontally.

18. The alarm of claim 17 wherein the lever is oriented so that a concave portion of the lever faces an air flow.

19. The alarm of claim 17 wherein the lever is substantially bell shaped when viewed substantially vertically.

20. A dryer system configured to detect obstructions in an exhaust duct, the dryer system comprising:
a dryer comprising:
an enclosure configured to hold items to be dried; and
a heat source configured to provide dry, heated air to the enclosure;
an exhaust duct configured to remove moist air from the enclosure; and
an alarm unit in fluid communication with the exhaust duct, the alarm unit comprising:
a lever hingedly suspended in the exhaust duct;
a sensor configured to detect a displacement of the lever; and
a logic device communicatively coupled to the sensor;
wherein the alarm unit is configured to monitor the displacement of the lever over a period of time when the dryer is in operation and to generate an alarm condition upon detecting that the displacement of the lever is insufficient.
